(19) United States
(12) Patent Application Publication
(10) Pub. No.: US 2014/0260716 A1
(43) Pub. Date: Sep. 18, 2014

(54) STOP TEETH FOR A PINION AND INPUT SHAFT ASSEMBLY

(71) Applicants: Daniel C. Simon, Freeland, MI (US); Eric D. Pattok, Frankenmuth, MI (US)

(72) Inventors: Daniel C. Simon, Freeland, MI (US); Eric D. Pattok, Frankenmuth, MI (US)

(73) Assignee: Steering Solutions IP Holding Corporation, Saginaw, MI (US)

(21) Appl. No.: 13/795,561

(22) Filed: Mar. 12, 2013

(51) Int. Cl. B62D 3/12

(52) U.S. Cl. CPC B62D 3/12
USPC 74/30

(57) ABSTRACT

A steering system having a pinion and an input shaft is disclosed. The pinion includes an outer surface and at least one pinion stop tooth located along the outer surface. The at least one pinion stop tooth has a pair of pinion pressure surfaces. The input shaft defines a recess configured for receiving the pinion. The input shaft includes an inner surface located within the recess and at least one shaft stop tooth located along the inner surface. The at least one shaft stop tooth has a pair of shaft pressure surfaces. A specific shaft pressure surface is positioned to generally oppose a specific pinion pressure surface, and the specific shaft pressure surface and the specific pinion pressure surface are generally parallel to one another.

### BACKGROUND OF THE INVENTION

The present invention relates to a steering system, and more particularly to a steering system having a pinion with pinion stop teeth and an input shaft with input shaft stop teeth.

### FIELD OF THE INVENTION

A rack and pinion type steering system includes a rack that is operatively coupled with steerable road wheels, as well as a pinion. An input shaft is connected to the pinion. As an operator rotates the hand wheel to maneuver a vehicle, the input shaft is rotated, which in turn rotates the pinion. Teeth on the pinion are meshed with teeth on the rack such that rotation of the pinion produces linear movement of the rack, which in turn causes the road wheels to turn.

A torsion bar is fixedly attached to both the input shaft and the pinion. During operation of the steering system, torque applied to the input shaft (by rotating the hand wheel) urges the torsion bar to also rotate in the same direction as the input shaft. Stop teeth located on both the pinion and the input shaft may be used to limit the amount of rotational displacement the torsion bar may experience. Spur gear type teeth, which have beveled or angled sides, are typically used as stop teeth. However, spur gear type teeth may have several drawbacks. For example, the amount of mechanical stress exerted on the spur gear type teeth is relatively high. Some other drawbacks of using spur gear type teeth may also include relatively large tolerances that result from the spur gear type tooth form and spacing, a relatively high level of complexity in changing allowed pinion rotation, and a relatively complex manufacturing process that is used to produce the stop teeth.

### SUMMARY OF THE INVENTION

In one embodiment, a steering system having a pinion and an input shaft is disclosed. The pinion includes an outer surface and at least one pinion stop tooth located along the outer surface. The at least one pinion stop tooth has a pair of pinion pressure surfaces. The input shaft defines a recess configured for receiving the pinion. The input shaft includes an inner surface located within the recess and at least one shaft stop tooth located along the inner surface. The at least one shaft stop tooth has a pair of shaft pressure surfaces. A specific shaft pressure surface is positioned to generally oppose a specific pinion pressure surface. The specific shaft pressure surface and the specific pinion pressure surface are generally parallel to one another.

In another embodiment, a steering system including a torsion bar, a pinion, and an input shaft is disclosed. The torsion bar has a first end portion and a second end portion. The pinion defines a pinion recess configured for fixedly securing the first end portion of the torsion bar with the pinion. The pinion includes an outer surface and at least one pinion stop tooth located along the outer surface. The at least one pinion stop tooth has a pair of pinion pressure surfaces. The input shaft defines a shaft recess configured for receiving the pinion. A portion of the shaft recess is fixedly secured to the second end portion of the torsion bar. The input shaft includes an inner surface located within the shaft recess and at least one shaft stop tooth located along the inner surface. The at least one shaft stop tooth has a pair of shaft pressure surfaces. A specific shaft pressure surface is positioned to generally oppose a specific pinion pressure surface. The specific shaft pressure surface and the specific pinion pressure surface are generally parallel to one another.

In yet another embodiment, a steering system including a rack, a torsion bar, a pinion, and an input shaft is disclosed. The torsion bar has a first end portion and a second end portion. The pinion defines a pinion recess configured for fixedly securing the first end portion of the torsion bar with the pinion. The pinion includes pinion teeth configured for meshing with the rack teeth. The pinion includes an outer surface and at least one pinion stop tooth located along the outer surface. The at least one pinion stop tooth has a pair of pinion pressure surfaces. The input shaft defines a shaft recess configured for receiving the pinion. A portion of the shaft recess is fixedly secured to the second end portion of the torsion bar. The input shaft includes an inner surface located within the shaft recess and at least one shaft stop tooth located along the inner surface. The at least one shaft stop tooth has a pair of shaft pressure surfaces. A specific shaft pressure surface is positioned to generally oppose a specific pinion pressure surface, and the specific shaft pressure surface and the specific pinion pressure surface are generally parallel to one another.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a vehicle rack and pinion assembly in accordance with an exemplary embodiment of the invention;

FIG. 2 is a cross-sectional view of an input shaft and a pinion shown in FIG. 1 in accordance with another exemplary embodiment of the invention;

FIG. 3A is a perspective view of the pinion shown in FIG. 2 in accordance with yet another exemplary embodiment of the invention;

FIG. 3B is an enlarged view of a pinion stop tooth shown in FIG. 3A in accordance with yet another exemplary embodiment of the invention;

FIG. 4A is an perspective view of an input shaft shown in FIG. 2 in accordance with yet another exemplary embodiment of the invention;

FIG. 4B is an enlarged view of an input shaft stop tooth shown in FIG. 4A in accordance with another exemplary embodiment of the invention;

FIG. 5 is a cross-sectional view of the input shaft and the pinion taken along section B-B in FIG. 2 in accordance with yet another exemplary embodiment of the invention;

FIG. 6A is a view of the input shaft in FIG. 5 rotating in a clockwise direction in accordance with yet another exemplary embodiment of the invention; and

FIG. 6B is a view of the input shaft in FIG. 5 rotating in a counterclockwise direction in accordance with yet another exemplary embodiment of the invention.

### DETAILED DESCRIPTION

Referring now to the Figures, where the invention will be described with reference to specific embodiments, without limiting same, a schematic illustration of a rack and pinion steering system 10 is shown. The rack and pinion steering system 10 includes a rack and pinion housing 12, a steering rack 14 slideably mounted in the housing, a pinion 16, and an input shaft 18. The rack and pinion system 10 also includes a torsion bar 20 (shown in FIG. 2) that is fixedly secured to both the pinion 16 and the input shaft 18. The pinion 16 includes teeth 17 which extend in a helical pattern. The teeth 17 located on the pinion 16 meshingly engage with teeth 19 located on the steering rack 14. The input shaft 18 is rotated about a central axis A-A by a hand wheel (not shown in FIG. 1). The rotation of the input shaft 18 rotates the pinion 16. Rotation of the pinion 16 moves the steering rack 14 relative to the housing 12. The steering system 10 also includes a left wheel 30 coupled to a left steering knuckle 34 and a right wheel 32 coupled to a right steering knuckle 36. A left tie rod 40 is connected to the rack 14 by a left inner ball joint 42 and to the left steering knuckle 34 by a left outer ball joint 44. A right tie rod 46 is connected to the rack 14 by a right inner ball joint 48 and to the right steering knuckle 36 by a right outer ball joint 50.

FIG. 2 is a cross-sectional view of the pinion 16, the input shaft 18, and the torsion bar 20. In the embodiment as shown, the pinion 16 includes a recess 52 to receive the torsion bar 20. In one exemplary embodiment, an interference fit I1 between a first end portion 51 of the torsion bar 20 and a portion 54 of the recess 52 secures the torsion bar 20 to the pinion 16. The input shaft 18 also includes a recess 56 as well to receive the torsion bar 20. An interference fit I2 between a second end portion 58 of the torsion bar 20 and a portion 60 of the recess 56 may also be used to fixedly secure the torsion bar 20 to the input shaft 18 as well.

A portion 62 of the pinion 16 is received by the recess 56 of the input shaft 18. Specifically, in one embodiment the recess 56 of the input shaft 56 may include at least a first diameter D1 and a second diameter D2, where the first diameter D1 is greater than the second diameter D2. A portion 64 of the recess 56 includes the first diameter D1, and is configured to receive the portion 62 of the pinion 16. A remaining portion 66 of the recess 56 includes the second diameter D2, and is configured to receive the second end portion 58 of the torsion bar 20. In one embodiment, a plurality of needle bearings 70 may be located within the portion 64 of the recess 56 between the pinion 16 and the input shaft 18. The needle bearings 70 may be used to substantially prevent axial movement between the pinion 16 and the input shaft 18.

Referring now to both FIGS. 2 and 3A, the pinion 16 includes an outer surface 74 and at least one pinion stop tooth 76 that projects outwardly from the outer surface 74. Specifically, FIG. 3A illustrates a plurality of pinion stop teeth 76. The pinion stop teeth 76 extend axially along a portion the pinion 16. Each pinion stop tooth 76 is positioned between two trough portions 78. Each pinion stop tooth 76 includes a top land 80 as well as two pinion pressure surfaces 82. The top land 80 represents an outermost surface of a pinion stop tooth 86. Referring now to FIG. 3B, which is an enlarged view of one of the pinion stop teeth 76, the pinion pressure surfaces 82 each include a first end portion 84 that connects the pinion pressure surface 82 to the trough portion 78, and a second end portion 86 that connects the pinion pressure surface 82 to the top land 80.

Referring now to FIGS. 2 and 4A, the input shaft 18 also includes at least one input shaft stop tooth 96 located along an inner surface 92 the recess 56. In the embodiment as shown in FIG. 4A, a plurality of shaft stop teeth 96 are illustrated. The shaft stop teeth 76 extend axially along a portion the input shaft 18. Each shaft stop tooth 96 is positioned between two trough portions 100. Each shaft stop tooth 96 includes a top land 102 as well as two generally opposing shaft pressure surfaces 104. Referring now to FIG. 4B, the shaft pressure surfaces 104 each include a first end portion 106 that connects the shaft pressure surface 104 to one of the trough portions 100, and a second end portion 108 that connects the shaft pressure surface 104 to the top land 102.

Turning now to FIG. 5, a cross sectioned view of the pinion 16, the input shaft 18, and the torsion bar 20 taken along section line B-B shown in FIG. 2 is illustrated. The pinion stop teeth 76 and the stop shaft teeth 96 are provided for limiting the amount of rotational displacement or twisting of the torsion bar 20 relative to the pinion 16 and the input shaft 18. Each pinion pressure surface 82a-82h of the pinion 16 generally opposes a corresponding one of the shaft pressure surfaces 104a-104h of the input shaft 18. For example, a selected pinion pressure surface is labeled as 82a, and generally opposes a corresponding shaft pressure surface 104a. Likewise, another pinion pressure surface 82 is labeled as 82b, and generally opposes a corresponding shaft pressure surface 104b. A pressure surface 82c generally opposes a corresponding shaft pressure surface 104c, a pressure surface 82d generally opposes a corresponding shaft pressure surface 104d, a pressure surface 82e generally opposes a corresponding shaft pressure surface 104e, a pressure surface 82f generally opposes a corresponding shaft pressure surface 104f, a pressure surface 82g generally opposes a corresponding shaft pressure surface 104g, and a pressure surface 82h generally opposes a corresponding shaft pressure surface 104h.

The pinion pressure surface 82a and the shaft pressure surface 104a are positioned generally parallel with one another. Likewise, each of the pinion pressure surfaces 82b-82h are positioned generally parallel to the corresponding shaft pressure surfaces 104b-104h. In one exemplary embodiment, generally parallel means that the pinion pressure surfaces 82a-82h and the corresponding shaft pressure surfaces 104a-104h are parallel within about 0.05 millimeters of one another, as defined by American Society of Mechanical Engineers (ASME) Y14.5M-1994. However, it is understood other tolerance ranges may be used as well.

Each pinion pressure surface 82a-82h of the pinion 16 as well as each shaft pressure surface 104a-104h of the input shaft 18 are oriented to extend radially outwardly from the central axis A-A. Specifically, for example, if pinion pressure surface 82a was extended or projected radially inwardly towards the central axis A-A by a pinion line 110, then the pinion line 110 would intersect with the central axis A-A. Likewise, if the shaft pressure surface 104a was extended or projected radially inwardly towards the central axis A-A by a shaft line 112, then the shaft line 112 would intersect with the central axis A-A.

A distance D is measured between the pinion pressure surfaces 82a-82h and the corresponding shaft pressure surfaces 104a-104h. The amount of rotational displacement the torsion bar 20 experiences as the input shaft 18 is rotated during operation of the steering system 10 (FIG. 1) is based on the distance D. Specifically, if the input shaft 18 is rotated in either a clockwise C direction, a torque applied to the input shaft 18 will rotate the torsion bar 20 until the shaft pressure surfaces 104b, 104d, 104f and 104h make contact with the corresponding pinion pressure surface 82b, 82d, 82f, and 82h. Once the relevant shaft pressure surfaces 104b, 104d, 104f and 104h contact the corresponding pinion pressure surfaces 82b, 82d, 82f, and 82h, further torque applied to the input shaft 18 is not transferred to the torsion bar 20, but is instead transferred to the pinion 16.

If the input shaft 18 is rotated in the counterclockwise direction CC, a torque applied to the input shaft 18 will rotate the torsion bar 20 until the shaft pressure surfaces 104a, 104c, 104e and 104g make contact with the corresponding pinion pressure surface 82a, 82c, 82e, and 82g. Once the relevant shaft pressure surfaces 104a, 104c, 104e and 104g contact the corresponding pinion pressure surfaces 82a, 82c, 82e, and 82g, further torque applied to the input shaft 18 is not transferred to the torsion bar 20, but is instead transferred to the pinion 16. Likewise, if torque is applied to the pinion 16, the torsion bar 20 will rotate until the selected pinion pressure surface 82a-82h make contact with the shaft pressure surface 104a-104h.

Referring to FIGS. 5-6A, if the input shaft 18 is rotated in the clockwise direction C, an amount of pressure or force F1 exerted on the pinion pressure surface 82h by the shaft pressure surface 104h is generally uniformly distributed along the pinion pressure surface 82h. As seen in FIG. 6A, the force F1 is generally perpendicular to the pinion pressure surface 82h and the shaft pressure surface 104h. Referring to FIG. 6B, if the input shaft 18 is rotated in the counterclockwise direction CC, the amount of pressure or force F2 exerted on the pinion pressure surface 82a by the shaft pressure surface 104a is also generally uniformly distributed along the pinion pressure surface 82a. The force F2 is generally perpendicular to the pinion pressure surface 82a and the shaft pressure surface 104a. Likewise, referring to FIG. 5, if the pinion 16 is rotated in the clockwise C or counterclockwise direction CC, then the amount of force exerted by the selected pinion pressure surfaces 82a-82h on the corresponding shaft pressure surfaces 104a-104h is also generally uniformly distributed along the shaft pressure surfaces 104a-104h.

Referring generally to FIGS. 1-6B, the pinion stop teeth 76 of the pinion 16 and the shaft stop teeth 96 of the input shaft 18 allow for a generally uniform amount of pressure or force to be exerted on either the pinion pressure surfaces 82a-82h or the shaft pressure surfaces 104a-104h. Some types of stop teeth that are currently available for the pinion and input shaft include are spur type gear teeth having beveled or angled sides. These types of spur gear teeth tend to exert pressure on one another at an angle (due to the beveled or angled sides). In contrast, the pinion pressure surfaces 82a-82h and the shaft pressure surfaces 104a-104h are positioned generally parallel to one another, and therefore exert a generally uniform force on one another. A uniform force results in a reduced amount of stress exerted upon the pinion stop teeth 76 and the shaft stop teeth 96 when compared to the spur type gear teeth currently being used.

The pinion pressure surfaces 82a-82h and the shaft pressure surfaces 104a-104h are oriented to extend radially outwardly from the central axis A-A. Thus, the amount of tolerance variation between the pinion pressure surfaces 82a-82h and the corresponding shaft pressure surfaces 104a-104h is reduced or substantially eliminated. This reduction in tolerance variation results in enhanced or improved control over the amount of rotational displacement the torsion bar 20 may experience as the pinion 16 or the input shaft 18 is rotated during operation. The pinion stop teeth 76 and the shaft stop teeth 96 as described above may also result in easier indexing for manufacturing operations and reduced hoop stress and deflection in the pinion 16 and the input shaft 18.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering system, comprising:
a pinion having an outer surface and at least one pinion stop tooth located along the outer surface, the at least one pinion stop tooth having a pair of pinion pressure surfaces; and
an input shaft defining a recess configured for receiving the pinion, the input shaft including an inner surface located within the recess and at least one shaft stop tooth located along the inner surface, the at least one shaft stop tooth having shaft pressure surfaces, one of the shaft pressure surfaces being positioned to generally oppose a specific pinion pressure surface, the one of the shaft pressure surfaces and the specific pinion pressure surface positioned generally parallel to one another.

2. The steering system of claim 1, wherein generally parallel is defined as within about 0.05 millimeters.

3. The steering system of claim 1, further comprising a torsion bar, wherein the pinion defines a pinion recess that is configured for fixedly securing a first end portion of the torsion bar with the pinion.

4. The steering system of claim 3, wherein a portion of the recess of the input shaft is fixedly secured to a second end portion of the torsion bar.

5. The steering system of claim 1, wherein the pair of pinion pressure surfaces and the shaft pressure surfaces are each oriented and extend radially outwardly from a central axis A-A of the steering system.

6. The steering system of claim 1, further comprising a rack having rack teeth, wherein the pinion includes pinion teeth configured for meshing engagement with the rack teeth.

7. The steering system of claim 1, wherein the pinion includes a plurality of pinion stop teeth extending axially along the pinion.

8. The steering system of claim 1, wherein the input shaft includes a plurality of stop shaft teeth extending axially along the input shaft.

9. A steering system, comprising:
a torsion bar having a first end portion and a second end portion;
a pinion defining a pinion recess configured for fixedly securing the first end portion of the torsion bar with the pinion, the pinion including an outer surface and at least one pinion stop tooth located along the outer surface, the at least one pinion stop tooth having a pair of pinion pressure surfaces; and
an input shaft defining a shaft recess configured for receiving the pinion, a portion of the shaft recess fixedly secured to the second end portion of the torsion bar, the input shaft including an inner surface located within the shaft recess and at least one shaft stop tooth located along the inner surface, the at least one shaft stop tooth having shaft pressure surfaces, one of the shaft pressure surfaces being positioned to generally oppose a specific pinion pressure surface, the one of the shaft pressure surfaces and the specific pinion pressure surface positioned generally parallel to one another.

10. The steering system of claim 9, wherein generally parallel is defined as within about 0.05 millimeters.

11. The steering system of claim 9, wherein the pair of pinion pressure surfaces and the shaft pressure surfaces are each oriented to extend radially outwardly from a central axis A-A of the steering system.

12. The steering system of claim 9, further comprising a rack having rack teeth, wherein the pinion includes pinion teeth configured for meshing engagement with the rack teeth.

13. The steering system of claim 9, wherein the pinion includes a plurality of pinion stop teeth extending axially along the pinion.

14. The steering system of claim 9, wherein the input shaft includes a plurality of stop shaft teeth extending axially along the input shaft.

15. A rack and pinion steering system, comprising:
a rack having rack teeth;
a torsion bar having a first end portion and a second end portion;
a pinion defining a pinion recess configured for fixedly securing the first end portion of the torsion bar with the pinion, the pinion including pinion teeth configured for meshing engagement with the rack teeth, the pinion including an outer surface and at least one pinion stop tooth located along the outer surface, the at least one pinion stop tooth having a pair of pinion pressure surfaces; and
an input shaft defining a shaft recess configured for receiving the pinion, a portion of the shaft recess fixedly secured to the second end portion of the torsion bar, the input shaft including an inner surface located within the shaft recess and at least one shaft stop tooth located along the inner surface, the at least one shaft stop tooth having shaft pressure surfaces, one of the shaft pressure surfaces being positioned to generally oppose a specific pinion pressure surface, the one of the shaft pressure surfaces and the specific pinion pressure surface positioned generally parallel to one another.

16. The rack and pinion steering system of claim 15, wherein generally parallel is defined as within about 0.05 millimeters.

17. The rack and pinion steering system of claim 15, wherein the pair of pinion pressure surfaces and the pair of shaft pressure surfaces are each axially aligned and extend radially outwardly from a central axis A-A of the rack and pinion steering system.

18. The rack and pinion steering system of claim 15, wherein the pinion includes a plurality of pinion stop teeth extending axially along the pinion.

19. The rack and pinion steering system of claim 15, wherein the input shaft includes a plurality of stop shaft teeth extending axially along the input shaft.
